(19) United States
(12) Patent Application Publication
(10) Pub. No.: US 2005/0066329 A1
(43) Pub. Date: Mar. 24, 2005

(54) Method for determining priority-dependent computing-time distribution in a priority-controlled multiprocess computing system

(76) Inventors: Gerhard Fischer, Maxhutte-Deglhof (DE); Martin Hurich, Ihrlerstein (DE); Josef Neumayer, Teugn (DE); Thierry Siberil, Regensburg (DE); Christian Zahn, Schwabhausen (DE); Herbert Ziegler, Rain (DE)

Correspondence Address: BAKER BOTTS, LLP, 910 LOUISIANA, HOUSTON, TX, 77002-4995, US

(21) Appl. No.: 10/981,245

(22) Filed: Nov. 4, 2004

Related U.S. Application Data
(63) Continuation of application No. PCT/EP03/50076, filed on Mar. 21, 2003.

(30) Foreign Application Priority Data
May 7, 2002 (DE) 10220341.5

(51) Int. Cl. G06F 9/46

(52) U.S. Cl. 718/100

(57) ABSTRACT

A method for determining priority-dependent computing time distribution in a priority-controlled multiprocess computing system, comprising the following steps: creation of a measuring process with a given computing time and a given priority; repeated execution of said measuring process during a given measuring time period; determination of the number of executions of said measuring process within the measuring time period and determination of the priority-dependent computing time distribution according to the number of executions of the measuring process during the measuring time period and the given computing time of the measuring process.

### CROSS-REFERENCE TO RELATED APPLICATION OR PRIORITY

This application is a continuation of co-pending International Application No. PCT/EP03/50076 filed Mar. 21, 2003, which designates the United States, and claims priority to German application number DE10220341.5 filed May 7, 2002.

### FIELD OF THE INVENTION

The invention relates to a method for determining priority-dependent computing-time distribution in a priority-controlled multiprocess computing system.

### BACKGROUND OF THE INVENTION

In multiprocess computing systems, it is possible to manage a plurality of processes which have different functions and which appear to the user to run simultaneously. A priority is assigned to the individual processes in this context, said priority determining the allocation of the available computing time by a process management. The distribution of computing time by the process management is coordinated in accordance with so-called scheduling methods in this context, wherein preemptive or non-preemptive scheduling methods as well as static or dynamic scheduling methods can be used, for example, depending on the requirements and the limiting conditions. In the case of non-preemptive process management, for example, the process which currently has the highest priority is started after a process ends.

In such multiprocess computing systems, it is desirable to specify the priority-dependent computing-time distribution. This is important firstly in order to determine how much computing time is required by a process having a preset priority. If for example numerous processes having a high priority are managed, a process having a low priority receives only relatively little computing time. The computing time which is available for a process having a preset priority therefore varies during the operation of a multiprocess computing system depending on the priorities of the other processes.

Secondly, the priority-dependent specification of the computing-time distribution is desirable in order to determine how much computing time is expended by processes having priorities which are higher than a preset priority threshold. For the purpose of specifying the distribution of computing time, it is customary to consider background processes having a preset priority and a known computing time, which processes are continuously repeated in multiprocess computing systems, such as e.g. a system idle loop. In this context, the number of repetitions of the background process is measured during a measuring period. On the basis of the known computing time of the background process and the number of repetitions of the background process during the measuring period, it is then possible to specify the total computing time with is expended by the background process during the measuring period. This then indicates the computing time which is expended by other processes having a higher priority during the measuring period.

This known method is however disadvantageous, firstly due to the fact that it can only be used with background processes which have a preset constant computing time and continuously repeat themselves. If the background processes which are used for measuring require a variable computing time, however, this method results in measuring errors, since the variable computing time is not recorded in the measurement.

A further disadvantage of this known method derives from the fact that the priority threshold is established by the priority of the background process which is used for measuring. Therefore it is only possible to specify the computing time which is expended by processes having a higher priority than the background process. Using this method, however, it is not possible to specify the computing time which is expended by processes above a desired priority threshold.

A further known method for specifying the priority-dependent computing-time distribution provides for capturing in each case a start and end of a process having a known priority. This method firstly offers the advantage that the priority-dependent computing-time distribution can also be determined by those multiprocess computing systems which feature exclusively processes having variable computing time. Secondly, the computing-time distribution can be determined concurrently for different priorities using this method, since the measurement is not limited to background processes having an established priority. However, the relatively significant use of hardware resources and computing time is a disadvantage of this method.

### SUMMARY OF THE INVENTION

The invention therefore addresses the problem of improving the known method which was described at the beginning, to the effect that the computing-time expenditure of processes above or below a desired priority threshold can be measured without requiring background processes which have a constant computing time.

Taking as a point of departure the known method which was described at the beginning, the object is achieved by (a) generating a separate measuring process having a preset computing time (T_{RECH}) and a preset priority (PRIO_{MESS}), wherein the priority of the measuring process is freely selectable, (b) repeatedly executing the measuring process (2) during a preset measuring period (T_{MESS}), (c) determining the number (i) of executions of the measuring process (2) within the measuring period (T_{MESS}), and (d) specifying the priority-dependent computing-time distribution depending on the number (i) of executions of the measuring process (2) during the measuring period (T_{MESS}) and the preset computing time (T_{RECH}) of the measuring process (2).

The invention encompasses the general technical teaching, to use a separate measuring process having a preset priority and a preset computing time for specifying the priority-dependent computing-time distribution in a multiprocess computing system.

This firstly offers the advantage that the priority threshold can be freely established when specifying the priority-dependent computing-time distribution, since the priority of the measuring process is freely selectable. Secondly, by using a measuring process having a preset computing time, the claimed method can also be applied in the context of process management methods in which the computing time of all other processes is variable.

The invention provides for the measuring process to be repeatedly executed during a measuring period, wherein the number of executions of the measuring process is captured. On the basis of the preset computing time of the measuring process and the number of executions during the measuring period, it is shown how much computing time was expended by the measuring processes during the measuring period. For this, the number of repetitions of the measuring process is preferably multiplied by the preset computing time of the measuring process. This value corresponds to the computing time which is available for processes having the priority of the measuring process.

From this value, it is also possible to derive how much computing time is expended by processes having a higher priority. If a measuring process having a preset priority value n−1=10 receives 20% of the available computing time, for example, this means that the processes having higher priorities n≧10 expend 80% of the available computing time.

The measuring process preferably replaces at least one process having a lower priority during the measurement. In an embodiment of the invention, however, the measuring process replaces all processes having a lower priority. However, it is also possible for the processes having a lower priority than the measuring process to be suspended during the measuring period.

In an embodiment of the invention, the measuring period is significantly greater than the computing time of the measuring process, thereby ensuring that the measured number of the executions of the measuring process is unbiased as far as possible. The measuring period can encompass 100 ms, for example, but greater or smaller values for the measuring period are also possible.

Furthermore, provision is preferably made for the specification of the priority-dependent computing-time distribution to be carried out repeatedly during the operation of the multiprocess computing system, in order to capture changes which are caused, for example, by any intervening change in the computing time which is required by the processes. Therefore the lengthening of the computing time which is required by a process, for example, results in a change in the priority-dependent computing-time distribution. The specification of the priority-dependent computing-time distribution therefore occurs regularly at preset measuring intervals which can be 500 ms long, for example.

However, it must be noted that the specification of the priority-dependent computing-time distribution, as claimed in the invention, itself expends computing time. Assuming a measuring interval of 500 ms and a measuring period of 100 ms, carrying out the claimed method requires e.g. 20% of the computing time which is available for processes below the priority of the measuring process.

In a variant of the invention, provision is therefore made for the measuring interval, the measuring period and/or the computing time of the measuring process to be adjusted depending on other variables. This is preferably done by specifying the computing load of the multiprocess computing system and adapting the measuring interval, the measuring period and/or the computing time of the measuring process accordingly.

The claimed specification of the priority-dependent computing-time distribution presupposes that the computing time of the measuring process is known. It is therefore preferable for a process which has a preset known computing time to be used as a measuring process.

Alternatively, however, it is also possible for a process whose computing time is not initially known, and is therefore specified in the context of the claimed method, to be used as a measuring process. This specification of the computing time of the process which is used as a measuring process can take place in a calibration method before the actual method, for example. The measuring process is activated for this purpose, and a start time point and end time point of the measuring process are measured in order to derive the computing time of the measuring process therefrom. Alternatively, however, the computing time of the process which is used as a measuring process can also take place “online” during the actual method, e.g. by measuring the start time point and the end time point of the measuring process when the measuring process is executed. Finally, the computing time of the measuring process can also take place after the end of the measuring period, but before the specification of the priority-dependent computing-time distribution.

The invention can be used both with preemptive and with non-preemptive (cooperative) process management methods, which are known to the person skilled in the art and therefore need not be described further. It is also possible to use hybrid forms of preemptive and non-preemptive process management methods within the scope of the invention. Furthermore, the invention can be used with either static or dynamic process management methods, wherein any combinations of preemptive and non-preemptive process management methods with static and dynamic process management methods are possible. Moreover, the notion of a process in the context of the invention must be understood in the general sense, and also includes tasks, threads and program modules, for example.

### BRIEF DESCRIPTION OF THE DRAWINGS

Further advantageous developments of the invention are described herein or explained in greater detail below with the description of the preferred exemplary embodiment of the invention and with reference to the figures, in which:

FIG. 1 shows the claimed method in the form of a flow diagram,

FIG. 2 shows a variant of the claimed method in the form of a flow diagram, and

FIG. 3 shows a time diagram for the purpose of illustrating the claimed method.

### DETAILED DESCRIPTION OF EMBODIMENTS OF THE INVENTION

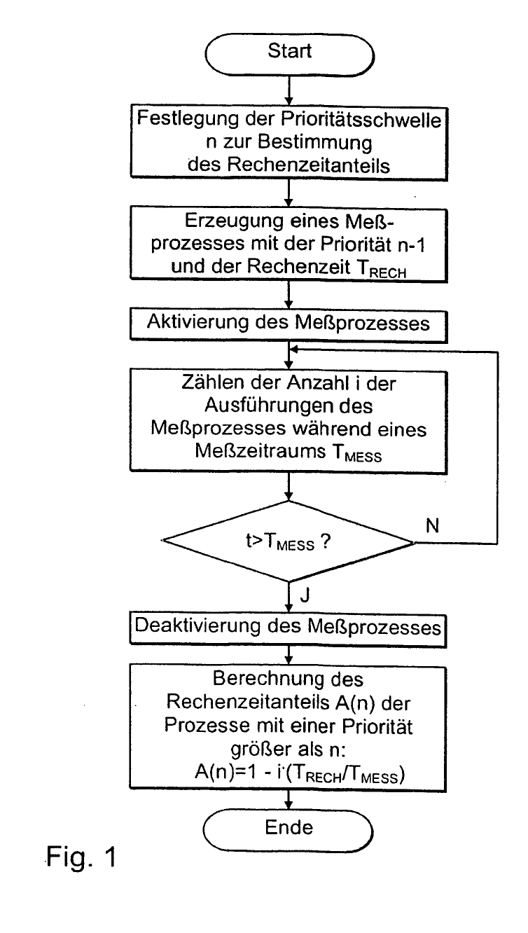

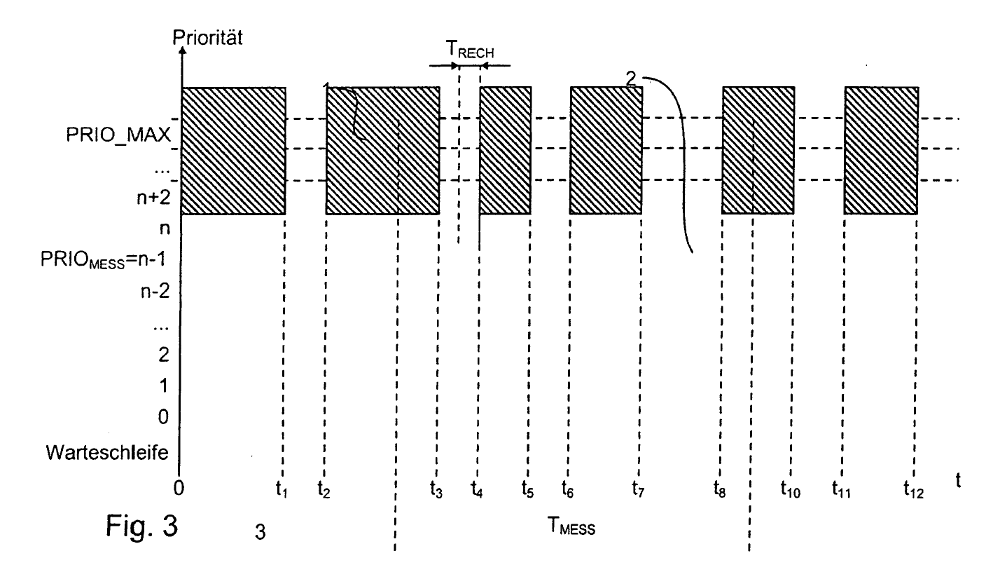

The flow diagram which is shown in FIG. 1 allows the specification of the computing-time portion which is expended in a multiprocess computing system by processes 1 whose priority is greater than or equal to a priority threshold n as illustrated schematically in the time diagram in FIG. 3.

In order to achieve this, the priority threshold n is initially preset in a first step, wherein the priority threshold n is freely selectable so that the computing-time distribution can be specified depending on priority for different priorities.

A measuring process 2 is then generated whose priority is PRIO_{MESS}=n−1. This means that all processes whose priority is greater than or equal to the priority threshold n take precedence over the measuring process 2. The measuring process 2 has a preset computing time T_{RECH} in this context, so that the computing time which is expended by the measuring process 2 can be specified easily. Moreover, after its execution, the measuring process 2 is immediately ready for a further execution again, and therefore the measuring process 2 is automatically repeated in the absence of another process which has a higher priority.

The measuring process 2 is then activated in a next step, such that the measuring process replaces all processes which have a lower priority.

During a preset measuring period T_{MESS}, the number i of executions of the measuring process 2 within the measuring period T_{MESS} is then determined in a loop, wherein continuous checking at the end of the loop ascertains whether the measuring period T_{MESS} has expired.

After expiration of the measuring period T_{MESS}, the measuring process is then deactivated.

Finally, the computing-time portion A of the processes 1 whose priority is greater than or equal to the priority threshold n is calculated, in accordance with the following formula, from the measured number i of executions of the measuring process 2 during the measuring period T_{MESS}, the measuring period T_{MESS} and the preset computing time T_{RECH} of the measuring process 2:

$$A ( n ) = 1 - i ( n ) \cdot \frac{{T}_{RECH}}{{T}_{MESS}}$$

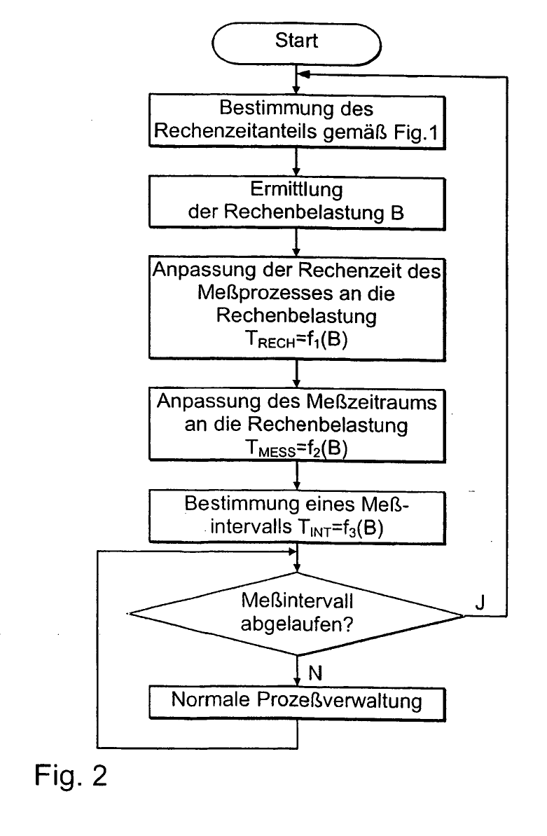

FIG. 2 shows a variant of the claimed method as described above, in which the measurement of the computing-time portion A which is allotted to processes having a priority greater than or equal to n is continuously repeated in a loop.

Furthermore, the computing load B of the multiprocess computing system is continuously determined in the loop, in order to adapt the measurement to the computing load B.

For this, the computing time T_{RECH} of the measuring process is established in the loop as a function of the computing load B.

In addition, the measuring period T_{MESS} is also specified as a function of the computing load B.

Finally, a measuring interval TINT is specified in the loop as a function of the computing load B, wherein the measuring interval TINT indicates the time intervals at which the claimed measuring method is carried out as per FIG. 1.

After expiration of the measuring interval T_{INT}, the loop is executed again, wherein the computing-time portion A is specified as per FIG. 1 in each case.

The invention is not restricted to the preferred exemplary embodiment which is described above. Indeed, a multiplicity of variants and modifications are possible, which likewise make use of the inventive idea and therefore fall within the scope of protection.

1. A method for determining priority-dependent computing-time distribution in a priority-controlled multiprocess computing system, said method comprising the following steps:
a) generating a separate measuring process having a preset computing time and a preset priority, wherein the priority of the measuring process is freely selectable,
b) repeatedly executing the measuring process during a preset measuring period,
c) determining the number of executions of the measuring process within the measuring period,
d) specifying the priority-dependent computing-time distribution depending on the number of executions of the measuring process during the measuring period and the preset computing time of the measuring process.

2. A method as claimed in claim 1, wherein the at least one process whose priority is lower than the priority of the measuring process is replaced or stopped by the measuring process during the measuring period.

3. A method as claimed in claim 1, wherein all processes whose priority is lower than the preset priority of the measuring process are replaced or stopped by the measuring process during the measuring period.

4. A method as claimed in claim 1, wherein the number of repetitions of the measuring process during the measuring period is multiplied by the preset computing time of the measuring process, in order to determine the computing time which is available during the measuring period for a process having the preset priority.

5. A method as claimed in claim 1, wherein the measuring period is significantly greater than the computing time of the measuring process.

6. A method as claimed in claim 1, wherein at least one repetition with a preset measuring interval.

7. A method as claimed in claim 6, wherein the measuring interval is significantly greater than the measuring period.

8. A method as claimed in claim 1, wherein the measuring interval and/or the computing time of the measuring process and/or the measuring period is changed.

9. A method as claimed in claim 8, wherein the computing load of the multiprocess computing system is determined, and the measuring interval and/or the computing time of the measuring process and/or the measuring period is adapted depending on the computing load.

10. A method as claimed in claim 1, wherein the computing time of the measuring process is determined before the generation and/or before the activation of the measuring process.

11. A method as claimed in claim 1, wherein the computing time of the measuring process is determined during the execution of the measuring process.

12. A method as claimed in claim 1, wherein the computing time of the measuring process is determined after the end of the measuring period and before the specification of the priority-dependent computing-time distribution.
